(19) United States
(12) Patent Application Publication
(10) Pub. No.: US 2018/0057778 A1
(43) Pub. Date: Mar. 1, 2018

(54) Process Adjustments for Uniform Beer Making

(71) Applicant: PicoBrew, Inc., A Delaware Corporation, Seattle, WA (US)

(72) Inventor: James B. Mitchell, Seattle, WA (US)

(21) Appl. No.: 15/249,828

(22) Filed: Aug. 29, 2016

(51) Int. Cl. C12C 3/08; C12C 7/00

(52) U.S. Cl. CPC C12C 3/085; C12C 7/00

(57) ABSTRACT

A beer making system may adjust the beer making process based on the age and provenance of hops to achieve a designed flavor profile. Hops may be analyzed and packaged, with the analysis stored for recall by a beer making system. When the hops are used during beer making, compensations may be made to the recipe parameters to compensate for estimated changes in the hops performance. In one use case, hops may be analyzed and sealed into single-use packages, which may be subsequently used with an automated or semi-automated beer making machine. A database lookup may be performed at beer making to adjust a recipe to increase or decrease time, temperature, or other parameters of a beer making process.

### BACKGROUND

The flower of the hops plant has been historically used in beer making. Hops are used to add bittering, flavor, and aroma to beer, as well as acting as a preservative. The hops flowers have several delicate oils that change and degrade over time, which can cause differences between beers made with hops of different ages. The hops may also degrade over time when exposed to oxygen, light, or other environmental factors.

### SUMMARY

A beer making system may adjust the beer making process based on the age and provenance of hops to achieve a designed flavor profile. Hops may be analyzed and packaged, with the analysis stored for recall by a beer making system. When the hops are used during beer making, compensations may be made to the recipe parameters to compensate for estimated changes in the hops performance. In one use case, hops may be analyzed and sealed into single-use packages, which may be subsequently used with an automated or semi-automated beer making machine. A database lookup may be performed at beer making to adjust a recipe to increase or decrease time, temperature, or other parameters of a beer making process.

A recipe management system may create kits for making beer that may have a specific target beer style or flavor profile. The kits may include hops and other ingredients that may degrade over time, and the system may include process parameters that may be varied based on the ingredient degradation. The system may permit adjustments to various flavor characteristics with a given set of ingredients at beer making time, and may change the amount of possible variation based on the age and availability of the ingredients.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a sequence of adjusting brewing recipes.

FIG. 2 is a diagram illustration of an embodiment showing a system for beer making, including a controller that may adjust recipe parameters for the degradation of hops.

FIG. 3 is a flowchart illustration of an embodiment showing a method for creating a recipe kit.

FIG. 4 is a flowchart illustration of an embodiment showing a method for calculating hops amounts.

FIG. 5 is a flowchart illustration of an embodiment showing a method for adjusting recipe parameters at brewing time.

### DETAILED DESCRIPTION

Hops Degradation Management

A beer making system may adjust process parameters to compensate for the degradation of hops over time. Hops flowers are used in beer making for bittering, flavor, and aroma. Many varieties of hops have various oils, waxes, and other components that may change in intensity over time. A beer making system may determine a change in the processing times, for example, to achieve a target extraction from hops. Such compensation may help make two batches of the same beer to be more consistent.

Hops may be analyzed, packaged, and identified for use. In some cases, the packaging may have a barcode, radio frequency identification (RFID) tag, or other identifier. A beer making machine may identify the hops at the point of use, and may determine the original analysis of the hops, then calculate an anticipated degradation of the hops. From the degradation, changes may be made to the brewing recipe to compensate for the degradation.

In some cases, the hops analysis information may be stored in a database that may be available over a network. In such a case, the beer making machine may capture the identification, send the identification to a server over a network, and may receive the hops analysis information. In some cases, the server may perform various degradation calculations or recipe compensations and transmit the same to the beer making system.

The hop analysis information may include any information about the provenance and performance of the hops, as well as any other information. The provenance information may include hops variety, manufacturer or source, processor, process methods, or other information. The performance information may include the amount of alpha and beta acids, essential oils, or other parameters.

Different varieties of hops may degrade in different manners. Some varieties may degrade faster than others, and some may degrade beta acids faster than alpha acids. A table, function, or degradation curve may be used to estimate the degradation of specific varieties of hops over time. In many cases, the degradation may be assumed based on room temperature dry storage of the hops in a specific type of container. In many cases, the container may be an air tight container that may be vacuum sealed or may have nitrogen or other non-reactive gas to minimize degradation.

Recipe Management System

A recipe management system for beer making may create a baseline recipe for a specific beer and may identify an ingredient kit that may be capable of making the desired beer. At the time a beer is made, any hops degradation may be analyzed to identify process changes that may compensate for the hops degradation.

The recipe management system may create a recipe and a given ingredient kit. In some cases, the recipe may be merely selected from a list of preexisting recipes, although some systems may have the capability for users to create their own custom recipes.

The ingredient kit may be designed to make the intended recipe and may be sized such that compensations to the recipe parameters may result in the intended beer, even considering the degradation of the ingredients over time. In many cases, additional quantity of certain ingredients may be included so that the beer making system may have sufficient room to adjust the recipe parameters to achieve a desired beer. The ingredient kit may be designed, for example, to brew the desired beer within six months of packing.

A beer making system may provide for additional changes to a given recipe at beer making time. In such a use case, the capabilities of a given ingredient kit may be used as a basis for permitting changes to the beer. A user may be presented with a range of possible changes, such as changing the bitterness of the beer for example. The system may calculate the amount of bitterness that may be achieved by the hops on hand, which may be less potential bitterness than the same amount of hops would have been capable of producing when the hops were packaged.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

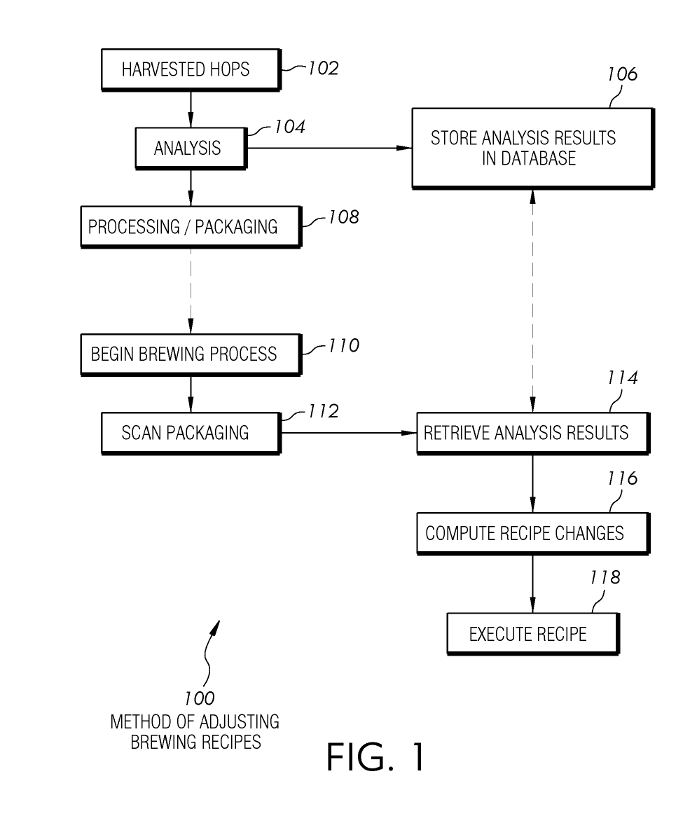

FIG. 1 is a diagram illustration of an embodiment 100 showing a sequence for making beer where the recipe may be adjusted based on degradation of ingredients.

Beer making may involve several steps. Malted grains may be mashed to extract sugars. The sugars from the mashing sequence may then be processed in a boiling cycle. Hops may be added at various stages of the boiling cycle. In general, bittering hops may be added for a relatively long period of time to extract alpha acids from the hops. Beta acids are more volatile than alpha acids and tend to boil off during such extended boil times. Separate charges of hops may be added to extract beta acids and other aromatics that may contribute to the flavor and aroma of a beer, and hops for these purposes are typically added near the end of the boil cycle or at a fermentation stage.

Hops degrade over time, changing their potency. The process of embodiment 100 may compensate for the degradation by adjusting a recipe at the time of the brewing process.

Harvested hops may be received in block 102 and an analysis may be performed in block 104. The analysis results may be stored in a database in block 106. The hops may be processed and packaged in block 108.

Typical hops analysis may include alpha and beta acid content, and some systems may include other factors, such as aromatic content, lipid analysis, or other analysis. These performance factors may be analyzed at the time the hops may be processed and packaged, and the results may be stored for later retrieval.

Hops may be processed in several different manners. In some cases, hops cones may be packaged whole or compressed into plugs. Sometimes, hops cones may be ground and pressed into pellets. In still other cases, the essential oils, acids, or other factors may be extracted from the hops and packaged as liquid or dried extracts.

The brewing process may start in block 110. As a part of the brewing process, the ingredient packaging may be scanned in block 112 and the analysis results may be retrieved in block 114. Based on the time that may have lapsed from the initial analysis, changes to the recipe may be computed in block 116 prior to executing the recipe in block 118.

In many cases, hops may be packaged with an identifier that may be used to link back to analysis results. The mechanism for storing and retrieving the analysis results may include storing the results in a remote, computer accessible database and making a call over a network to find the data. Another mechanism may be to print the analysis results on a label or to store the analysis results in a barcode, radio frequency identification tag, or other data storage device that may travel with the ingredient.

The degradation of the hops may be computed by using a predefined degradation curve that may estimate a performance factor for the hops based on a length of time that may have elapsed since an analysis was performed. In many cases, such curved may be generated for different hops varieties and for different performance factors.

When the degradation of the hops may be calculated, the recipe may be adjusted to compensate for the degradation. For example, an older bittering hops package may be adjusted to increase the boiling time to achieve the same target bitterness that was originally specified in a recipe. In another example, a hops extract oil that may have been tested several months prior may be adjusted to add additional drops of extract to a fermenting vessel to achieve a desired amount of flavoring. In both cases, the applicable performance factor for the hops may be estimated to decrease, so a compensation may be calculated for the recipe to achieve the original intent of the recipe.

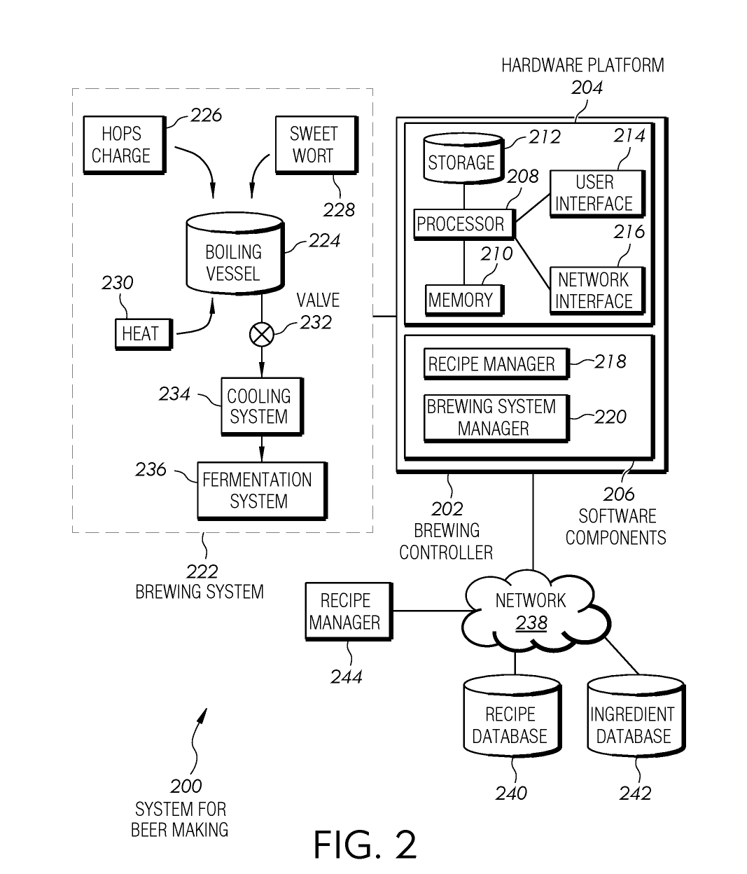

FIG. 2 is a diagram of an embodiment 200 showing components that may be included in a brewing controller 202 and a brewing system 222.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a controller 202 that may have a hardware platform 204 and various software components. The controller 202 as illustrated represents a conventional computing device, although other embodiments may have different configurations, architectures, or components.

In many embodiments, the controller 202 may be a server computer. In some embodiments, the controller 202 may still also be a desktop computer, laptop computer, netbook computer, tablet or slate computer, wireless handset, cellular telephone, game console or any other type of computing device. In some embodiments, the controller 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the controller 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system on which various software components and services may operate, such as a recipe manager 218 and a brewing system manager 220.

A recipe manager 218 may be a component that may assist a user in creating, editing, storing, retrieving, and otherwise managing recipes. In many cases, the recipes may include both an ingredients list as well as control parameters that may be used with a brewing system 222.

The brewing systems manager 220 may provide control and monitoring functions, based on the capabilities of the brewing system 222. Some brewing systems may be automatically or semi-automatically operated, and as such, the recipes may include sequences, temperatures, timing control points, and other parameters for a brewing sequence. Such control points may be automatically actuated in some brewing systems, while in other brewing systems, a human operator may perform some of the operations.

The brewing system 222 may illustrate merely one example of a brewing system that may be controlled by a brewing system manager 220. In this example, a boiling vessel 224 may receive a hops charge 226 and sweet wort 228. Heat 230 may be applied to process the sweet wort 228 prior to chilling and fermenting.

In some cases, one or more hops charges 226 may be added at various stages during a boil cycle. Some brewing systems 222 may be capable of automatically adding the hops charges 226 to the boiling vessel 224. In some such cases, a recirculating system may be capable of automatically configuring itself to add various hops charges at different times during the boiling cycle. Such systems may be adjusted to add a hops charge earlier or later during a boiling cycle to compensate for the degradation of the hops over time.

After a boiling cycle may be completed, a brewing system manager 220 may halt the addition of heat 230 and a valve 232 may be opened to move the boiled liquid through a cooling system 234 and into a fermentation system 236. In some cases, a cooling operation may be performed in the boiling vessel 224, which may involve activating or adding a cooling system within the boiling vessel or within the fermentation system 236.

The brewing system manager 220 may be capable of automatically stopping a boiling cycle. In such cases, the brewing system manager 220 may be capable of adjusting the stop point as one mechanism for adjusting the length of time a hops charge may undergo the boiling cycle. For example, a boil cycle may be lengthened or shortened to compensate for the degradation of either, one, or all of bittering hops, flavor hops, or aroma hops.

A recipe manager 218 may access various databases across a network 238, including a recipe database 240 and an ingredient database 242. The recipe database 240 may contain various recipes for different beers, and may include a specific recipe that may be used with a given ingredient kit. In some cases, a remote recipe manager 244 may be a web-based tool through which a user may select a recipe and order an ingredient kit for the recipe.

An ingredient database 242 may include performance parameters for various ingredients. In many cases, the ingredient database 242 may be populated as an ingredient or ingredient kit may be packaged. In a typical use case, an identification tag may be assigned to the packaging and stored in the ingredient database 242 along with the performance parameters for the ingredient. At the time the ingredient may be used, the identification tag may be queried against the ingredient database 242 and the ingredient's initial performance parameters may be retrieved. From these data, adjustments may be made to the recipe to compensate for any degradation of the ingredients over time.

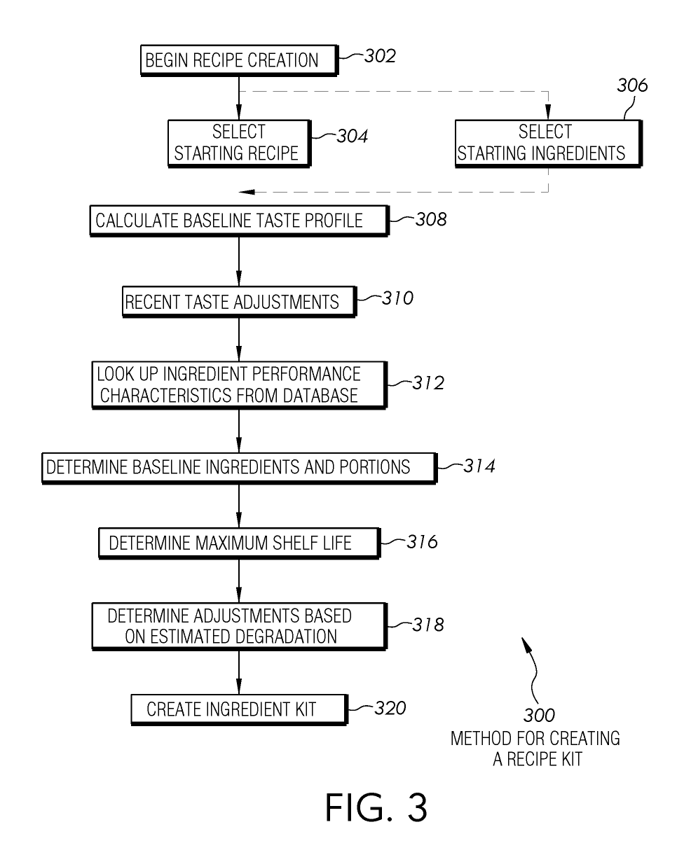

FIG. 3 is a flowchart illustration of an embodiment 300 showing a method for creating an ingredient kit for a recipe where compensation may be made for the shelf life of products in the ingredient kit.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 may illustrate one method for creating an ingredient kit for a beer recipe. The ingredient kit may be sized to operate with a given beer making system, but may include enough extra ingredients to compensate for a shelf life of the ingredient kit. The extra amounts of ingredients may be used by a beer making system to adjust various recipe process parameters to compensate for degradation of the ingredients.

Recipe creation may begin in block 302. A user might select a starting recipe in block 304, or may select a set of starting ingredients in block 306. From the starting ingredients, a baseline taste profile may be generated in block 308. A baseline taste profile may include items such as the color, bitterness, specific gravity, and other parameters. In some cases, the baseline taste profile may attempt to match the taste profile to a predefined style of beer.

A user may be able to make adjustments to the taste profile in block 310. Adjustments may be items such as increasing or decreasing the mouthfeel or fullness of the beer, increasing or decreasing bitterness, changing sweetness or dryness of the finished product, or some other adjustment. The taste adjustments may be made by changing the mashing parameters of the grains, increasing or decreasing the amount of time and temperature hops charges are in contact with the liquid, and other recipe parameters. The taste adjustments may be used to create a desired recipe for a specific beer.

In many cases, a customized recipe may be created and stored by a user. The recipe details may be printed off for later use, or when an automated or semi-automated brewing system may be used, the recipe may be retrieved and used to program a controller for the brewing system. In many such uses, the recipe may be stored on a centralized database and retrieved at the time the recipe may be executed.

Ingredient performance characteristics may be looked up in block 312. The performance characteristics may include items like the amount of alpha and beta acids contained in a variety of hops in inventory, the amount of sugar and color extraction obtained from various grains in inventory, or other characteristics.

A set of baseline ingredient portions may be created in block 314. The baseline ingredient portions may include individual ingredients and their amounts for the desired beer. The baseline ingredient portions may be the ingredients and their portions that would be used if the beer were to be made on the date the recipe was defined.

In many cases, the baseline ingredient portions may be calculated to meet a given recipe. For example, a recipe with a desired amount of bittering may have the amount of hops calculated from the utilization percentage of a baseline recipe, the amount of alpha acids in the hops, and the batch size. The utilization percentage may take into account the specific gravity of the wort, the baseline amount of time used for boiling the hops, and other factors. Some recipes may have multiple charges of hops that may be added at different times during the boiling cycle, and each charge may include one or more varieties of hops.

A maximum shelf life of an ingredient kit may be determined in block 316. A maximum shelf life may be set to be one, two, three months, or more. Sometimes, a shelf life of 4, 5, 6, 7, 8, 9, 10, 11, 12 months or more may be used. The shelf life may assume a standardized storage profile, and in some cases, different shelf lives may be given for different storage profiles. For example, storage in a dry, room temperature pantry may have a shelf life of 3 months, but the same ingredients may have a shelf life of 6 or 9 months when stored in a refrigerator. The same ingredients may have a shelf life of 2 years when stored in a freezer, for example.

Adjustments may be made to the ingredient list based in the shelf life in block 318. The adjustments may be calculated by estimating the degradation of the ingredient at the maximum shelf life under the storage conditions. For example, the alpha acid of a variety of hops may be measured at 4.2% initially, but may be estimated to degrade at room temperature to 2.1% in six months, the maximum shelf life of the ingredient. In this example, the amount of hops may be increased so that at six months, adjustments may be made to the beer making process so that the same bitterness may be extracted within the parameters of a recipe.

After adjusting the amount of ingredients based on the anticipated shelf life, a final ingredient kit may be identified in block 320. In some cases, a customized ingredient kit may be made for a specific recipe.

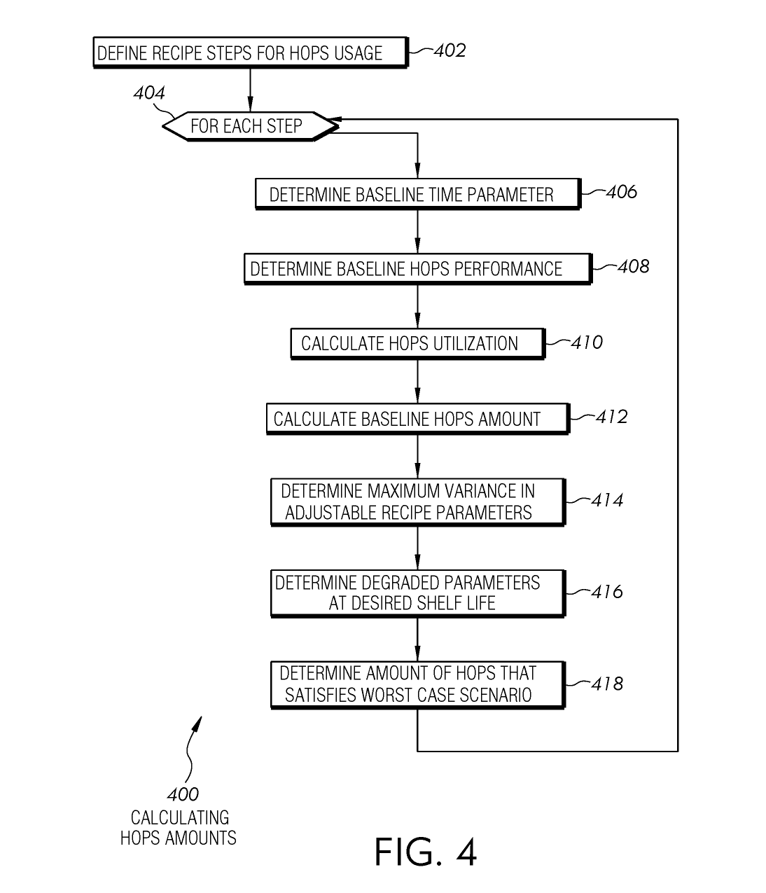

FIG. 4 is a flowchart illustration of an embodiment 400 showing a method for calculating hops amounts for a given recipe.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 illustrates one method for calculating hops amounts for a given recipe. The hops amounts may be calculated based on the adjustable recipe parameters and the estimated degradation of the hops at the end of the shelf life. Embodiment 400 may illustrate a simple method for calculating hops amounts for a given recipe.

Many complex recipes may have multiple hops charges, each containing two or more varieties of hops with each hops charge being added at a different stage during the boiling cycle. In such situations, calculating an amount of hops for each step in the brewing cycle may involve an iterative approach, where several different factors may be adjusted in an iterative manner to find a solution where a recipe may be executed at any time during the shelf life to yield the desired beer.

The recipe steps may be defined in block 402 for a particular beer. Each step may be analyzed in block 404.

For a given step in block 404, a baseline time parameter may be determined in block 406. A time parameter may be, for example, the length of time that a given hops charge may be added to the boil cycle. The time parameter may include a start time when the hops are initially added, and an end time, which may be the time the hops are removed or the time that the boil cycle may end. Many brewing systems may not have the capability to remove hops after adding.

A baseline set of hops performance parameters may be determined in block 408. The performance parameters may be the percentage of alpha and beta acids, as well as other parameters. The baseline parameters may be set by measuring the parameters for a given batch of ingredients. In many cases, the parameters may be taken from ingredients in current inventory.

The hops utilization may be calculated in block 410. Hops utilization may reflect the amount of performance, such as bittering, flavor, aroma, or other factors that may be expected given the recipe at the point that the hops may be added. Factors that may affect the hops utilization may be the specific gravity of the wort, temperature, and other factors. From these factors, the baseline hops amount may be calculated in block 412.

The maximum variance in adjustable recipe parameters may be determined in block 414. The recipe parameters for a hops addition may include the total time that a hops charge may be in contact with the liquid. Some recipes may have a limited amount of variance that may be possible given other recipe steps. For example, a bittering step may be increased in length no longer than the overall length of the boiling cycle.

The degraded performance parameters of the hops may be calculated in block 416. An amount of hops may be calculated in block 418. Four sets of calculations may be performed using the maximum variance of the adjustable recipe parameters and the maximum and minimum performance parameters of the hops. From these calculations, an amount of hops may be selected that may yield the desired recipe characteristics for all of the recipe conditions.

In a simple example, a boil time for a bittering hops change in a desired recipe may be set to be a maximum of 45 minutes. The maximum variance of this recipe parameter may be determined to be a range of 45 minutes at the maximum to 30 minutes at the minimum. The 30 minute value may be the shortest amount of time for the boil to have its desired effect on the sugars within the wort, in this case. The hops charge may start with an alpha acid content of 4.2% and, at the end of the shelf life, may have an alpha acid content of 3.7%.

Continuing with the example, an amount of hops may be determined from calculations assuming the maximum alpha acid content at the minimum boil time, as well as the minimum alpha acid content at the maximum boil time. The larger of the two calculated values may be selected as the amount of hops for a particular recipe. Such a result may ensure that the recipe parameters may be adjusted to achieve a desired result given a fixed amount of hops that may degrade over an expected range. The degradation range may be calculated from an expected shelf life.

This example is merely one simplified example of how the range or variance of a recipe may be combined with the range of hops performance parameters to calculate an amount of hops for a given recipe. Other systems may have different limitations that may limit the ability to vary the recipe parameters, which may include limitations imposed by the brewing system and the ability or accuracy to control the system, recipe limitations where multiple ingredients are added at various sequences or steps of the process, or other limitations.

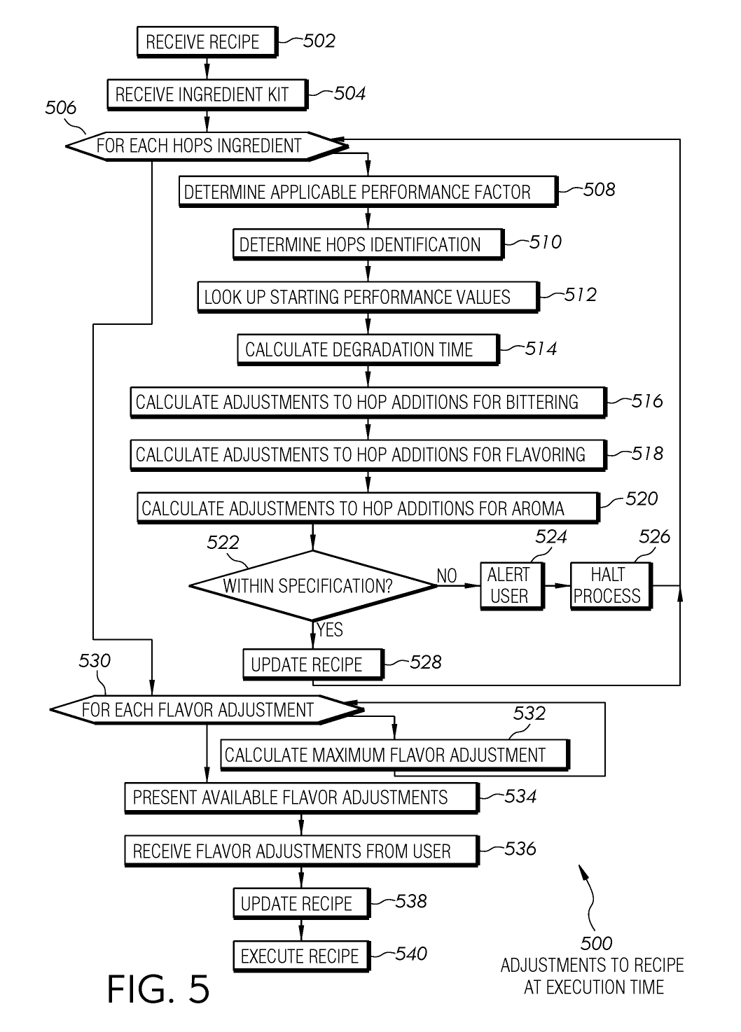

FIG. 5 is a flowchart illustration of an embodiment 500 showing a method for adjusting a beer brewing recipe for the degradation of ingredients.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 500 may illustrate one method for adjusting recipe parameters for the degradation of ingredient effectiveness. An ingredient kit may be analyzed to find its original performance characteristics, then adjustments may be made to the recipe parameters to achieve a desired beer.

Embodiment 500 may be performed by a controller for a beer brewing system. In some cases, many of the steps may be performed by a remote service that may be accessed over a network. Such a remote service may identify an ingredient kit, determine changes to a recipe based on degradation of the ingredients, and may also include adjustments to a recipe based on flavor characteristics that a user may input. Such a remote service may then download an updated recipe to a beer brewing system.

A recipe may be received in block 502, along with an ingredient kit in block 504. In many cases, an ingredient kit may be packaged for a specific recipe as described in embodiment 400, and such an ingredient kit may be sized with enough materials so that a brewing system may compensate for the degradation of ingredients.

For each hops ingredient in block 506, the applicable performance factor may be determined in block 508. Because hops may be used for bittering, flavor, and aroma, the alpha acids dominate in bittering, and the beta acids and essential oils dominate for flavor and aroma, respectively.

The hops identification may be determined in block 510 and the starting performance values may be looked up in block 512. In many cases, a barcode reader, radio frequency identification tag, or other identifier may be decoded to find an identifier for the package of hops, and the starting performance values may be looked up in a database. In many such cases, a call may be made to a central database that may store the hops performance characteristics. In other cases, the performance characteristics may be embedded in the packaging, such as in a human readable form and, in some cases, in a machine readable format.

The degradation time may be calculated in block 514 by determining the elapsed time from the current time to the time when the hops performance characteristics were measured. Based on the elapsed time, adjustments to the recipe parameters may be made for bittering in block 516, for flavoring in block 518, and for aroma in block 520.

If the adjustments are not within specifications of the recipe in block 522, the user may be alerted in block 524 and the process may be halted in block 526. In such a case, the recipe adjustments dictated by the degradation of the ingredients may not yield the desired beer.

When the adjustments are within specification, the recipe may be updated in block 528 and the process may return to block 506.

In many brewing systems, a user may be able to adjust the flavor characteristics of a beer at brewing time. Such adjustments may include adjusting the mouthfeel, adjusting bitterness, flavor, or aroma of a beer, as well as adjusting the sweetness or dryness of the beer.

For each flavor adjustment in block 530, a maximum amount of available adjustment may be calculated in block 532. The maximum amount may be the range of adjustment based on the recipe parameters that are already adjusted for the degradation in ingredients. These adjustments may be presented to the user in block 534, and the user input may be received in block 536. The recipe may be adjusted in block 538 and executed in block 540.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A wort making system comprising:
a wort manufacturing hardware system comprising a mechanism to boil liquid and a controllable system to cause a boil cycle to end;
a computer processor configured to:
receive a recipe, said recipe defining a boil time;
determine a default hops boil duration;
determine an adjusted hops boil duration, said adjusted hops boil duration being determined at least in part from a hops packaging date and a current date; and
cause said boil cycle to end after said adjusted hops boil duration, said adjusted hops boil duration starting when said hops charge is added to said liquid.

2. The wort making system of claim 1, said computer processor further configured to:
receive an identifier for said hops charge; and
determine said hops packaging date from said identifier.

3. The wort making system of claim 2, said computer processor further configured to:
calculate a time difference between said hops packaging date and said current date;
estimate a hops degradation based on said time difference; and
calculate said adjusted hops addition time based on said hops degradation.

4. The wort making system of claim 1, said computer processor further configured to:
receive an identifier for said hops charge;
transmit said identifier across a network; and
receive a message across said network.

5. The wort making system of claim 4, said message comprising said adjusted hops boil duration.

6. The wort making system of claim 4, said message comprising said hops packaging date.

7. A wort recipe management system executable on a computer processor, said wort recipe management system configured to:
receive a recipe objective, said recipe objective comprising a bitterness objective and a first hops variety;
determine a starting hops performance characteristic based on a starting level of alpha acids for said first hops variety;
determine a maximum variance for said hops performance characteristic;
determine a boil cycle comprising a hops boil duration, said hops boil duration being determined from said bitterness objective, said starting hops performance characteristic, and said maximum variance; and
publish a recipe, said recipe comprising said boil cycle.

8. The wort recipe management system of claim 7, said publish comprising transmitting said recipe to a wort making system.

9. The wort recipe management system of claim 7, said publish comprising generating a human-readable version of said recipe.

10. The wort recipe management system of claim 7 further configured to:
determine said maximum variance by determining a maximum degradation of said hops performance characteristic over a maximum shelf life.

11. The wort recipe management system of claim 7 further configured to:
receive a starting recipe, said starting recipe comprising said recipe objective.

12. The wort recipe management system of claim 7 further configured to:
receive a starting recipe;
from said starting recipe, determine said recipe objective.

13. The wort recipe management system of claim 7 further configured to:
receive a taste variance, said taste variance being a change to said recipe objective;
determining a proposed change to said recipe based on said taste variance, said proposed change being a process parameter change;
determining that said proposed change is within said maximum variance; and
updating said recipe to include said process parameter change.

14. The wort recipe management system of claim 7 further configured to:
receive a taste variance, said taste variance being a change to said recipe objective;
determining a proposed change to said recipe based on said taste variance, said proposed change being a process parameter change;
determining that said proposed change is outside said maximum variance; and
rejecting said proposed change.

15. A wort making system comprising:
a wort manufacturing hardware comprising a system for boiling wort under processor control;
a user interface;
a processor configured to:
receive a recipe for an intended beer, said recipe comprising process parameters;
receive an analysis date for a hops charge;
determining an adjustment to said intended beer, said adjustment being a change to said process parameters compensating for degradation of said hops charge;
causing said recipe to be executed using said adjustment.

16. The wort making system of claim 15, said analysis date for said hops charge being received by reading a tag on a hops package.

17. The wort making system of claim 16, said tag being one of a group composed of:
a barcode;
a radio frequency identification tag; and
a nearfield communication tag.

18. The wort making system of claim 15, said process parameters comprising a boiling time for said hops charge.
